(19) United States
(12) Patent Application Publication
(10) Pub. No.: US 2024/0424454 A1
(43) Pub. Date: Dec. 26, 2024

(54) SYSTEM AND METHOD FOR SUPPRESSION OF LITHIUM BASED FIRES

(71) Applicant: Full Circle Lithium Corp., Toronto (CA)

(72) Inventors: William L. BOURCIER, Livermore, CA (US); Robert Thomas CURRIN, Nahunta, GA (US)

(73) Assignee: Full Circle Lithium Corp., Toronto (CA)

(21) Appl. No.: 18/750,194

(22) Filed: Jun. 21, 2024

Related U.S. Application Data
(60) Provisional application No. 63/522,781, filed on Jun. 23, 2023.

(51) Int. Cl. B01F 21/00; A62C 3/16; A62D 1/00; B01F 35/00

(52) U.S. Cl. CPC B01F 21/02; A62D 1/0035; B01F 35/187; A62C 3/06; A62C 3/16

(57) ABSTRACT

The present disclosure describes a method and a system of producing a fire suppression medium. The method includes introducing a solvent and an alkali metal or a salt of the alkali metal into the mixer and dissolving the alkali metal or the salt of the alkali metal in the solvent to create an alkali metal solution. The method also includes filtering and analyzing a sample of the alkali metal solution. If the filtered alkali metal solution does not have a sufficient alkali metal content, the method includes introducing and dissolving additional alkali metal or the salt of the alkali metal into the alkali metal solution. If the filtered alkali metal solution has the sufficient alkali metal content, the method includes filtering the alkali metal solution to remove residual alkali metal or residual salt of the alkali metal to create and collect a saturated alkali metal solution.

### CROSS-REFERENCE TO RELATED APPLICATION

This application claims priority to U.S. Provisional Patent Application Ser. No. 63/522,781, filed on Jun. 23, 2023, which is incorporated by reference herein.

### TECHNICAL FIELD

The present disclosure relates generally to a system and method for producing alkali metal solutions and their uses in preventing fires, extinguishing fires, suppressing fires or quenching fires, and more specifically to a system and method for preventing, suppressing, extinguishing or quenching lithium based fires.

### BACKGROUND

With the goal of reducing carbon emissions globally, a crucial step towards developing electric vehicles (including, but not limited to, cars, trucks, boats, planes, trains, scooters and all other forms of electric powered transportation) (collectively, “EVs”) and the EV industry, alternative energy sources such as wind and solar, portable computers and phones, and tools and machinery of all kinds, involved the development of energy storage units, such as lithium ion batteries (singular “LIB”, and plural “LIBs”). However, LIBs contain, along with stored energy, potentially hazardous chemical constituents. As such there are dangers associated with the use, charging and recycling of LIBs, including, but not limited to, fire hazards. Other hazards include inadvertent or uncontrolled discharge of the remaining stored energy resulting in fires or explosions, and the release of toxic chemicals that may include, among others, flammable hydrogen gas and hydrogen fluoride.

LIBs contain residual energy proportional to the amount of elemental lithium remaining on their anodes. Under normal use as batteries, this energy is safely released as an electrical current. This energy may still be contained to some degree within the battery and must be accounted for to avoid sudden release as heat, which can be explosive and can initiate fires, which may result if there is trauma to the LIBs. Once started, the fire can consume other battery materials such as the electrolyte solution and battery separator, which also may oxidize and contribute to the potentially harmful reaction.

Trauma to the LIBs may be caused by different environmental conditions, including, but not limited to, collisions of EVs. Where LIBs may be ignited due to a collision or other accident, a LIBs fire may be initiated. Even if the initial fire is extinguished using conventional means, such as water or carbon dioxide, the LIBs may reignite at a later time. For example, even if the initial fire is extinguished at the site of a collision, and after the EV is towed away to an external lot, it may reignite hours or even days later due to a runaway lithium oxidation reaction, as there is still energy contained within the battery, and there may still be ongoing reactions within the LIBs. Not only is extinguishing of the initial fire important, but it is also crucial to prevent future reignitions of LIBs.

### SUMMARY

According to a broad aspect of the present invention, there is provided a method of producing a fire suppression medium. The method includes introducing a solvent into a mixer and introducing an alkali metal or a salt of the alkali metal into the mixer. The method further includes dissolving the alkali metal or the salt of the alkali metal in the solvent to create an alkali metal solution. The method also includes filtering a sample of the alkali metal solution and analyzing the sample of the filtered alkali metal solution. If the filtered alkali metal solution does not have a sufficient alkali metal content, the method includes introducing additional alkali metal or the salt of the alkali metal into the mixer and dissolving the additional alkali metal or the salt of the alkali metal into the alkali metal solution. A second sample of the alkali metal solution is then analyzed for sufficient alkali metal content. If the filtered alkali metal solution has the sufficient alkali metal content, the method includes filtering the alkali metal solution to remove residual alkali metal or residual salt of the alkali metal to create a saturated alkali metal solution and collecting the saturated alkali metal solution.

In one feature, the method may further include collecting the residual alkali metal or salt of the alkali metal.

In another feature, the method may further include re-introducing the residual alkali metal or the salt of the metal into the mixer.

In one feature, the dissolving of the alkali metal or the salt of the alkali metal in the solvent may include stirring the alkali metal solution with a stirrer in the mixer.

In another feature, the solvent may be water.

In yet another feature, the alkali metal is the salt of the alkali metal.

In another feature, the alkali metal is lithium.

In yet another feature, the lithium is a lithium salt.

In another feature, the salt of the alkali metal may include lithium carbonate, lithium bicarbonate, or lithium chloride, or a mixture of any one of the salts of the alkali metals.

In yet another feature, the sufficient alkali metal content is at least 2,200 mg/L.

In yet another feature, the sufficient alkali metal content is between 2,200 mg/L and 2,500 mg/L.

According to a broad aspect of the present invention, there is provided a system for producing a fire suppression medium. The system includes a mixer, where the mixer receives a solvent and an alkali metal or a salt of the alkali metal. The mixer further dissolves the alkali metal or the salt of the alkali metal into the solvent to create an alkali metal solution. The system further includes a filter. The filter is fluidly connected to the mixer, and the filter separates a residual alkali metal or a residual salt of the alkali metal from the alkali metal solution, leaving a saturated alkali metal solution.

In one feature, the mixer may include a stirrer.

In another feature, the system may include a storage for the solvent.

In yet another feature, the system may include a storage for the alkali metal or the salt of the alkali metal.

In one feature, the solvent may be water.

In another feature, the alkali metal may be the salt of the alkali metal.

In yet another feature, the alkali metal may be lithium.

In another feature, the lithium may be a lithium salt.

In yet another feature, the salt of the alkali metal may include lithium carbonate, lithium bicarbonate, or lithium chloride, or a mixture of any one of the salts of the alkali metals.

In one feature, the saturated alkali metal solution may have an alkali metal content of at least 2,200 mg/L.

In another feature, the saturated alkali metal solution may have an alkali metal content between 2,200 mg/L and 2,500 mg/L.

According to a broad aspect of the present invention, there is provided a fire suppression medium. The fire suppression medium includes a saturated alkali metal solution. The saturated alkali metal solution includes a solvent and an alkali metal or a salt of the alkali metal dissolved in the solvent. The saturated alkali metal solution has an alkali metal content of at least 2,200 mg/L.

In one feature, the solvent may be water.

In another feature, the alkali metal may be the salt of the alkali metal.

In yet another feature, the alkali metal may be lithium.

In another feature, the lithium may be a lithium salt.

In yet another feature, the salt of the alkali metal may include lithium carbonate, lithium bicarbonate, or lithium chloride, or a mixture of any one of the salts of the alkali metals.

In another embodiment, the saturated alkali metal solution has an alkali metal content of less than 2,500 mg/L.

In one feature, a fire extinguisher includes the fire suppression medium.

In another feature, the fire extinguisher is portable.

In yet another feature, the fire extinguisher has a volume of 2.5 gallons.

In another feature, a pressurized gas fire suppression system includes a pressurized gas fire supply and the fire suppression medium.

In another feature, an engineered fire suppression system includes a suppression agent, wherein the suppression agent includes the fire suppression medium.

In another feature, a pail includes the fire suppression medium, where the pail is configured to refill a fire extinguisher, a pressurized gas fire suppression system or an engineered fire suppression system.

In another feature, a drum includes the fire suppression medium, where the drum is configured to refill a fire extinguisher, a pressurized gas fire suppression system or an engineered fire suppression system.

In yet another feature, a tote includes the fire suppression medium, where the tote is configured to refill a fire extinguisher, a pressurized gas fire suppression system or an engineered fire suppression system.

In yet another feature, a bulk container includes the fire suppression medium, where the bulk container is configured to refill a fire extinguisher, a pressurized gas fire suppression system or an engineered fire suppression system.

In yet another feature, a bulk transportation container includes the fire suppression medium, where the bulk transportation container is configured to transport at least one of a lithium fire residue, a damaged lithium ion battery and a suspected to be damaged lithium ion battery.

According to a broad aspect of the present invention, there is provided a composition for use as a fire suppression medium. The composition includes a solution. The solution includes an alkali metal or a salt of an alkali metal and a solvent.

In one feature, the solvent may be water.

In another feature, the alkali metal may be the salt of the alkali metal.

In yet another feature, the alkali metal may be lithium.

In another feature, the lithium may be a lithium salt.

In yet another feature, the salt of the alkali metal may include lithium carbonate, lithium bicarbonate, or lithium chloride, or a mixture of any one of the salts of the alkali metals.

In one feature, the saturated alkali metal solution may have an alkali metal content of at least 2,200 mg/L.

In another feature, the saturated alkali metal solution may have an alkali metal content between 2,200 mg/L and 2,500 mg/L.

According to a broad aspect of the present invention, there is provided a use of a composition for suppression or quenching fires. The composition includes a solution. The solution includes an alkali metal or the salt of an alkali metal and a solvent.

In one feature, the solvent may be water.

In another feature, the alkali metal may be the salt of the alkali metal.

In yet another feature, the alkali metal may be lithium.

In another feature, the lithium may be a lithium salt.

In yet another feature, the salt of the alkali metal may include lithium carbonate, lithium bicarbonate, or lithium chloride, or a mixture of any one of the salts of the alkali metals.

In one feature, the saturated alkali metal solution may have an alkali metal content of at least 2,200 mg/L.

In another feature, the saturated alkali metal solution may have an alkali metal content between 2,200 mg/L and 2,500 mg/L.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 depicts an example system for producing a fire suppression medium for suppressing lithium based fires and to prevent runaway lithium oxidation reactions;

FIG. 2A depicts an example method of producing a fire suppression medium for suppressing lithium based fires and to prevent runaway lithium oxidation reactions in accordance with the example system in FIG. 1;

FIG. 2B depicts an alternate method of producing a fire suppression medium for suppressing lithium based fires and to prevent runaway lithium oxidation reactions in accordance with the example system in FIG. 1;

FIG. 3 depicts an example method of using the fire suppression medium for suppressing lithium based fires and to prevent runaway lithium oxidation reactions;

FIG. 4 depicts another method of using the fire suppression medium for suppressing lithium based fires and to prevent runaway lithium oxidation reactions;

FIG. 5 depicts an example of a fire extinguisher prior to and after modification to use the fire suppression medium for suppressing lithium based fires and to prevent runaway lithium oxidation reactions;

FIG. 6 depicts another example of a fire extinguisher prior to and after modification to use the fire suppression medium for suppressing lithium based and to prevent runaway lithium oxidation reactions;

FIG. 7 depicts an example of a pressurized gas fire suppression system using the fire suppression medium for suppressing lithium based fires and to prevent runaway lithium oxidation reactions;

FIG. 8 depicts an example fire extinguisher product after modification to use the fire suppression medium for suppressing lithium based fires and to prevent runaway lithium oxidation reactions; and

FIG. 9 depicts an example of a transportation vessel for lithium based fire residue.

### DETAILED DESCRIPTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

In an embodiment of the present invention, there is provided an alkali metal (or a salt thereof) solution. In a preferred embodiment, there is provided a lithium or lithium salt solution. In a more preferred embodiment, there is provided a lithium chloride, carbonate or bicarbonate solution. In yet a more preferred embodiment of the present invention, there is provided a lithium solution that can be used to, suppress, extinguish, quench and/or prevent further fires associated with lithium based fires, or fires from LIBs. A person skilled in the art will understand that lithium based fires are fires that involve lithium, and include both fires that occur due to the ignition of lithium, and fires that occur due to the ignition of other elements or environment but where lithium is present. Examples of lithium based fires may include, but are not limited to, lithium storage areas that are on fire, and LIBs that ignite due to trauma. A person skilled in the art will recognize other examples of lithium based fires.

By way of general overview, there is also provided a method of preparing an alkali metal (or salt thereof) solution, more preferably a saturated lithium solution, which can be used, in a preferred embodiment, as a fire suppression, extinguishing or quenching medium for lithium based fires or fires from LIBs. A person skilled in the art will understand that the terms “suppression”, “extinguish”, “quench”, etc. may be used interchangeably to refer to eliminating, decreasing or reducing the activity, severity or degree of intensity of a fire. The alkali metal (or salt thereof) solution may also be used a fire preventer. A person skilled in the art will understand that the term “preventer” may be used to refer to the prevention of a fire starting or igniting. The method generally involves introducing an alkali metal (or salt thereof) into a solvent or solution (also referred to herein as a liquid solvent or solution), and dissolving the alkali metal or corresponding salt in said solvent or solution to create an alkali metal or corresponding salt solution. In a preferred embodiment the alkali metal is lithium and its corresponding salts. In a further preferred embodiment, the lithium salt can be selected from the group consisting of lithium carbonate, lithium bicarbonate and lithium chloride. In yet a more preferred embodiment, the lithium salt is lithium carbonate. A person skilled in the art will understand that the terms “alkali metal”, “alkali metal salt”, and “lithium”, may be used interchangeably to refer to preferred embodiments of the present invention. The specification is directed to discussing the preferred embodiments of the present invention, but it will be understood by a person skilled in the art that other embodiments are included in said disclosures.

The alkali metal or salt thereof, (e.g. such as, but not limited to, lithium carbonate) solution may then undergo a residence time, during which dissolving continues to occur, to allow for the alkali metal or salt thereof solution to become additionally saturated with any remaining alkali metal (e.g. such as, but not limited to, lithium carbonate particles. After the duration of the residence time, the remaining lithium carbonate particles are then filtered out, allowing a lithium carbonate solution to be collected. The resultant lithium carbonate solution may then be used in fire suppression devices, such as a handheld fire extinguisher, or a pressurized gas fire suppression system, to extinguish lithium based fires and to prevent runaway lithium oxidation reactions.

The use of a solution of an alkali metal or salt thereof of the present invention may be advantageous as fire suppression mediums when suppressing lithium or other LIBs based fires as it further prevents runaway oxidation reactions. Without wishing to be bound by any theory, the observed fire suppression, quenching or extinguishing of fire, particularly LIBs derived fires in the presence of embodiments of the present invention may relate to the reduction, suppression, etc. of alkali metal (e.g such as lithium) based oxidation reactions. Lithium based fires, for example, may include fires of LIBs or other lithium based batteries. Fires may start as a result lithium based car batteries in electric vehicles igniting during crashes, or where lithium based batteries may be subject to trauma or other extreme environmental conditions. In situations where there is a sudden or explosive release of heat, fires may initiate. Once started, the fire can consume other battery materials such as the electrolyte solution and battery separator, which also may oxidize and contribute to the potentially harmful reaction.

The lithium oxidation reaction may be the spark that ignites other combustible material. The overall heat production of the fire may be only partially due to the heat released in lithium oxidation. Most of the energy released may come from the ignition and burning of other combustible materials.

When prior art or other forms of suppression mediums are used to extinguish lithium based fires, the initial fire or fire caused by other combustible material, may be extinguished. Lithium oxidation may continue to occur, and may lead to further exothermic reactions. This may lead to the reignition of the fire after the prior art fire suppression mediums have been removed or have evaporated. For example, when extinguishing a fire involving a LIB, prior art systems may involve using water, an aqueous solvent or solution to immerse the LIB. The water, aqueous solvent or solution can oxidize the elemental lithium on the anode, freeing the lithium quantitatively for collection, but also releasing heat. Prior art aqueous solvents or solutions may be hydrolyzed in the reaction to produce hydrogen gas. The reaction is faster and more energetic in the presence of oxygenated (aerated) aqueous solvents or solutions, which supplies the oxidant as oxygen. However, the reaction can also proceed in the presence of water, an aqueous solvent or solution without oxygen present, where aqueous solvent or solution can act as the oxidant. This reaction releases about 40% less heat than one using free oxygen, but it releases hydrogen gas (which is not released when oxygen is present), which is then available for further reaction and poses its own dangers. When applying prior art aqueous solvents or solutions to the lithium based fire, the following reactions below may occur. In the first reaction, water is the lithium oxidant. In the second reaction, water and oxygen are the lithium oxidents.

Li₍ₛ₎+H₂O=Li⁺+OH⁻+½H₂

Li₍ₛ₎+¼O_{2(aq)}+½H₂O=Li⁺+OH⁻

As can be seen in the reactions above, the addition of water accelerates the reaction, as it acts as an oxidant. The addition of oxygen accelerates the reaction even further as it acts as a catalyst that further increases the reaction.

When using an alkali metal or salt thereof solution of the present invention (preferably, a saturated lithium solution and more preferably a saturated lithium carbonate solution), the magnitude of the heat-producing reactions may be greatly reduced. Specifically, the amount of heating can be reduced and the hydrogen gas is often not visible. In addition, by using an alkali metal solution (preferably, a lithium solution and more preferably a saturated lithium carbonate solution), the lithium in the fire may be prevented from engaging in further reactions, hence preventing a runaway lithium oxidating reaction. When applying a solution of the present invention to a lithium based fire, the two abovementioned reactions may not occur (or will be reduced) as the solution prevents the lithium in the vicinity of the fire from further oxidation and heat release.

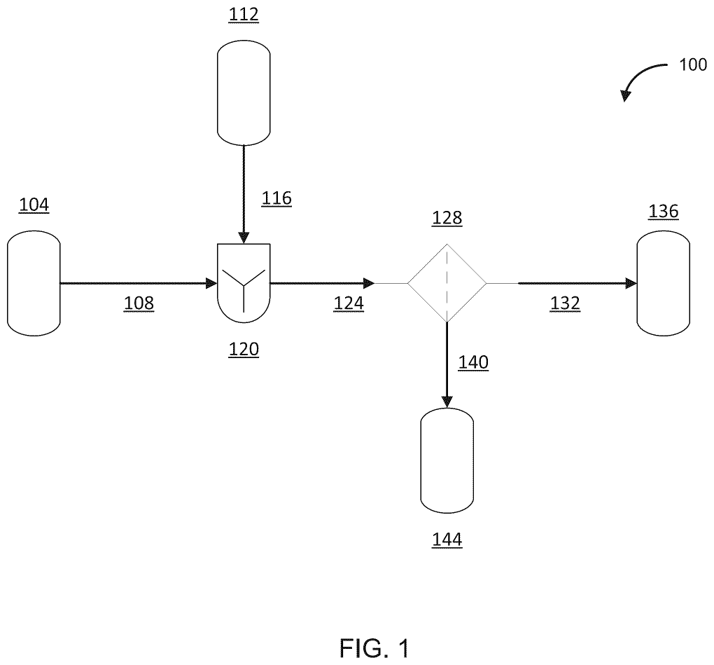

FIG. 1 depicts a system 100 for producing a saturated lithium based liquid aqueous solution. System 100 includes a liquid aqueous solvent or solution storage tank 104 (also referred to herein as storage tank 104 or tank 104) connected to a mixer 120 through an aqueous solvent or solution or liquid feed line 108 (also referred to herein as feed line 108), allowing aqueous solvent or solution to be sent from storage tank 104 to mixer 120. System 100 also includes a solid lithium storage 112 (also referred to herein as storage 112) connected to mixer 120 though a lithium feed line 116. Preferable lithium salts can also include lithium chloride and lithium bicarbonate. Mixer 120 allows for the dissolving of the solid lithium in aqueous solvent or solution over a predetermined residence time to create a mixture of a lithium solution and solid lithium. The predetermined residence time for the dissolving of the solid lithium in the aqueous solvent or solution allows for the saturation of the lithium solution. Mixer 120 is fluidly connected to filter 128, where any residual solid lithium may be extracted or filtered out from the mixture of the lithium solution and solid lithium. The resulting saturated liquid lithium solution may then be collected in storage tank 136 via collector line 132. Residual solid lithium carbonate that is extracted or filtered out may be collected in storage 144 via collector line 140. A person skilled in the art will recognize that while system 100 depicts the production of a saturated lithium based liquid aqueous solution using solid lithium, other embodiments of system 100 may produce saturated alkali metal based liquid aqueous solutions using solid alkali metals.

In the current embodiment, an aqueous solvent or solution may be provided to mixer 120 via feed line 108 from storage tank 104. The aqueous solvent or solution is preferably water. In a more preferred embodiment, purified water with a total dissolved salt content of less than 100 mg/L, and a total suspended solid content of less than 25 mg/L may be used. An aqueous solvent with a low level of impurities, such as purified water, is preferable to avoid precipitation of unwanted solids. Storage tank 104 may be of any size vessel that stores liquids, and is readily available through commercial means. In alternate embodiments, storage tank 104 may also store liquids under pressure. In other further embodiments, storage tank 104 may be another source of liquid, such as a continuous source of said liquid (not shown) or a water main line (not shown). A person skilled in the art will recognize the different sources and types of solutions or solvents that may be used in system 100.

Feed line 108 fluidly connects storage tank 104 to mixer 120 and provides a conduit for liquid delivery from storage tank 104 to mixer 120. In the current embodiment, feed line 108 may be a pipeline. In other embodiments, feed line 108 may include valves positioned along feed line 108 to allow control of the flow of aqueous solvent or solution from storage tank 104 to mixer 120. A valve will further allow for the control of specific aqueous solvent or solution volumes when mixing solid lithium carbonate and aqueous solvent or solution in mixer 120. A person skilled in the art will recognize that different valve types and different feed lines may be used in combination with each other for the controllable delivery and flow of liquid from storage tank 104 to mixer 120. It will also occur to a person skilled in the art that other forms of aqueous solvent or solution delivery may also be possible depending on the source of aqueous solvent or solution from storage tank 104. For example, aqueous solvent or solution may simply be hand delivered from storage tank 104 in a container to mixer 120.

Solid lithium storage 112 stores solid lithium (preferably lithium carbonate) and provides a source of solid lithium to be delivered to mixer 120 via lithium feed line 116. In an alternate embodiment (not shown), solid lithium storage 112 may store any alkali metal. However, in a more preferred embodiment, the solid lithium or solid lithium carbonate are particles, with a grain size of less than 25 microns. The greater surface area of the lithium particles will provide for greater effectiveness when dissolving the lithium particles in the aqueous solvent or solution. The solid lithium may also be from all different types of commercially available lithium. For example, commercially available lithium carbonate of technical grade may be used, or alternatively, other lower grades of unspecified compositions containing alkali metals, or preferably lithium, may be used as well. Impurities from the battery electrolyte solution and other battery materials may be present in minor or trace amounts may not affect the fire suppression effect of the resultant saturated lithium solution created by system 100 as further described below. As such, contaminated lithium carbonate by-product streams that result from battery recycling may be used as a source for solid lithium to be stored in solid lithium storage 112 to be used in system 100. Alternatively, as will be described further below, solid lithium may be recovered after the use of the saturated liquid lithium solution as a fire suppression medium and stored in solid lithium storage 112 for further use. Solid lithium storage 112 may be of any container that keeps the solid lithium dry. In certain embodiments, solid lithium carbonate storage 112 may even be temperature and humidity controlled to ensure that the solid lithium does not become moist. In other embodiments, solid lithium storage 112 may be a simple container. Solid lithium storage 112 may also be able to receive solid lithium from other sources and may act as a local storage prior to sending the solid lithium to mixer 120.

Lithium feed line 116 provides a conduit to deliver solid lithium from solid lithium storage 112 to mixer 120. In certain embodiments, lithium feed line 116 may be a conveyor belt. Alternatively, lithium feed line 116 may be a gravity fed pipeline. A person skilled in the art will recognize the different potential embodiments of lithium feed line 116 for the transport of solid matter. The solid lithium particles may be dispersed into mixer 120 via feed line 116. In certain embodiments, lithium feed line 116 may include a valve or other flow control mechanisms positioned along lithium feed line 116 to control the flow and the amount of solid lithium dispersed into mixer 120. Alternatively, in other embodiments, lithium feed line 116 may be substituted with an individual that sprinkles solid lithium particles (e.g. lithium carbonate) into mixer 120. In a further alternative embodiment, lithium particles (e.g. lithium carbonate) may be sprayed or dispersed over mixer 120. In another alternative embodiment, lithium particles (e.g. lithium carbonate) may be provided into mixer 120 as a slurry. A person skilled in the art will recognize the different delivery methods and or different embodiments of lithium feed line 116 that may be used.

Mixer 120 is configured to receive both the liquid solvent or solution and solid lithium and allows for the liquid and solid lithium to mix and further for the solid lithium to dissolve in the liquid over a predetermined residence time to create a mixture of a saturated lithium solution and residual solid lithium. In alternate embodiments, mixer 120 may include stirrers or other apparatus to further aid in the dissolving process. The addition of stirrers or other apparatus may further increase the efficacy of the dissolving process and/or reduce the amount of residence time required for an appropriate level of saturation to occur. The dissolving process and saturation process will be further discussed below.

In other embodiments, system 100 may further include an additional apparatus (not shown) for additional saturation to occur. Having an additional apparatus, such as a resting container, would allow for mixer 120 to further receive additional solid lithium and aqueous solvent or solution for the dissolving process, while allowing for a separate batch of mixture to undergo the saturation process.

Once the dissolving process and the saturation of the liquid lithium solution is complete, filter 128 may collect the resulting mixture of residual solid lithium that has yet to dissolve, and the saturated lithium solution, where filter 128 is configured to separate the residual solid lithium from the saturated lithium solution. In a preferred embodiment, filter 128 is able to filter out particles of sizes 5 microns or larger. In other embodiments of system 100, filter 128 may be substituted for other devices or apparatus that may be able to separate the residual solid lithium from the liquid saturated lithium solution. For example, in certain embodiments, system 100 may include a centrifuge and use centrifugation to separate the particles from the saturated lithium solution. A person skilled in the art will recognize the different mechanisms available to be included in system 100 to separate the saturated liquid lithium solution from the residual solid lithium.

Storage tank 136 is configured to receive the resulting saturated liquid lithium solution that may be used for lithium based fire extinguishing purposes via collector line 132. Storage tank 136 may be any vessel or container that is commercially available to hold said saturated liquid lithium solution. Collector line 132 may be any conduit that is able to receive and transport the saturated liquid lithium solution from filter 128 to storage tank 136. Collector line 132 may further include valves along the length of collector line 132 to control the flow of saturated liquid lithium solution.

Storage 144 is configured to receive the residual solid lithium that was filtered out from filter 128. Storage 144 may receive said residual solid lithium via collector line 140. Collector line 140 may be any delivery system to move the residual solid lithium from filter 128 to storage 144. Examples include a conveyor belt or a gravity fed pipeline, or alternatively a user may manually remove the solids from filter 128 and transport them to storage 144.

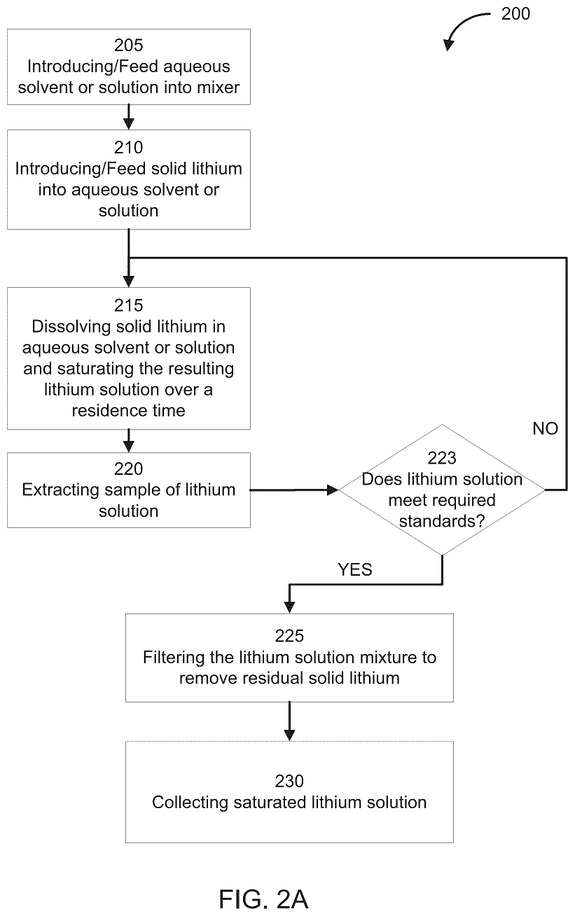

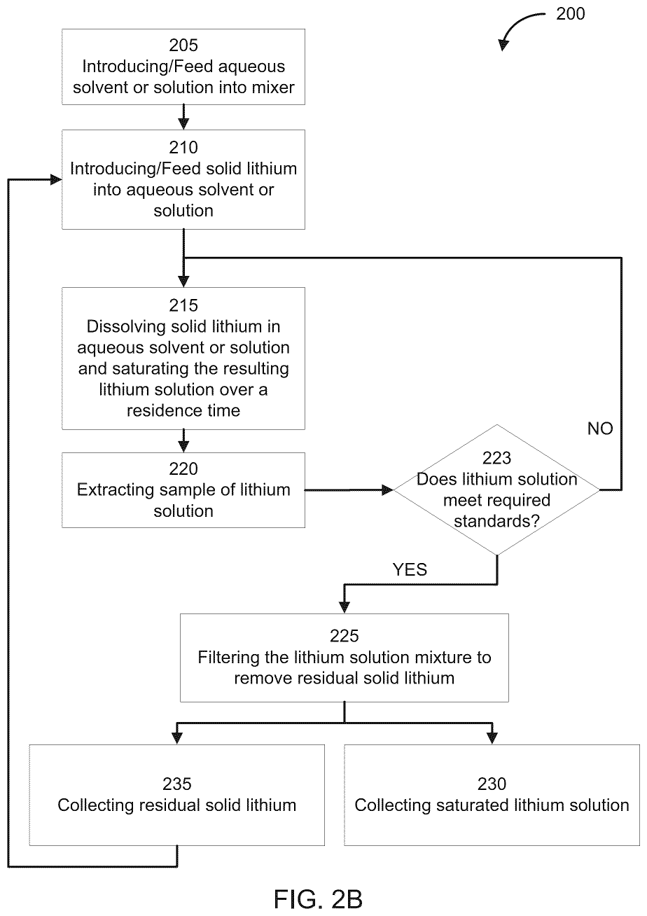

FIG. 2A depicts method 200 for producing the fire suppression medium for extinguishing lithium based fires and to prevent runaway lithium oxidation reactions.

Block 205 depicts introducing liquid into mixer 120 from storage tank 104 via liquid feed line 108. Block 210 depicts introducing solid lithium into mixer 120 from lithium storage 112 via lithium feed line 116.

As previously indicated, in certain embodiments, where the solid lithium is in the form of powder and/or particles, the solid lithium particles may be dispersed, sprayed or sprinkled or fed as a slurry over the liquid in mixer 120. The dispersion of the solid lithium particles over the liquid in mixer 120 may increase the efficiency of the dissolving of said solid lithium particles in the liquid. In addition, in other embodiments (not shown), other alkali metals may be introduced to the liquid in mixer 120.

In the current embodiment of method 200, liquid aqueous solvent or solution is received first by mixer 120, and then lithium particles are then dispersed into the aqueous solvent or solution in mixer 120. However, in other embodiments, it is contemplated that solid lithium may be introduced first into mixer 120, where liquid aqueous solvent or solution is then flushed into mixer 120. It is also contemplated that in other embodiments, the introduction of solid lithium and the aqueous solvent or solution into mixer 120 may occur concurrently.

It is also contemplated that in other embodiments that lithium storage 112 may store lithium or other alkali metals in different states. A person skilled in the art will recognize that should lithium, lithium carbonate or other alkali metals be introduced to mixer 120 in a non-solid state, that the order of introducing the aqueous solvent or solution and the non-solid alkali metal may be adjusted to optimize mixing based on methods known in the art.

Once both the liquid and lithium particles are received in mixer 120, the lithium particles will begin dissolving in the liquid water to create a lithium solution over a predetermined residence time. This is depicted at block 215.

The dissolving process may be provided as the following formulas:

Li₂CO₃₍ₛ₎+H₂O=2Li⁺+HCO₃_{^{−}}+OH⁻

Where the dissolved solid lithium carbonate is present as ionized lithium ions and bicarbonate ions in the solution.

In some embodiments, the dissolving of lithium particles (or other alkali metals, or more preferably lithium carbonate particles) in aqueous solvent or solution may happen without any external interference, however in the current embodiment, the dissolving of lithium particles in aqueous solvent or solution may be made further efficient through stirring the mixture of lithium particles and aqueous solvent or solution with a stirrer, allowing a reduction in residence time between the lithium particles and the aqueous solvent or solution. Alternatively in other embodiments, the dissolving of lithium particles in the aqueous solvent or solution may be made further efficient by adjusting the temperature or pressure of the liquid aqueous solvent or solution either prior to the introduction of the aqueous solvent or solution to mixer 120, or while dissolving in mixer 120. A person skilled in the art will recognize that the adjustment of temperature or pressure of the contents of mixer 120 may be determined based on the specific aqueous solvent or solution used, and also the specific alkali metal used. By making the dissolving more efficient, a higher concentration of lithium particles may be dissolved in aqueous solvent or solution over a shorter residence time, further saturating the lithium solution.

The above-mentioned factors affecting the efficiency of the dissolving process of the solid lithium within the aqueous solvent or solution also affects the predetermined residence time. The predetermined residence time may also be determined and/or affected depending on the concentration of lithium and the amount of liquid aqueous solvent or solution. The duration of residence time may further be affected based on the delivery method of the solid lithium to mixer 120, and the efficiency of the dissolving step. Furthermore, the duration of residence time may also be affected by the preferred saturation level of lithium within the resulting lithium solution. In addition, a reduction in residence time may also allow for a reduction in production cost. In addition, the duration of residence time may also be affected based on the particle size of the solid lithium being introduced into mixer 120. A person skilled in the art will recognize the different factors that may affect or impact the predetermined residence time, and will also recognize the different factors that may lower the predetermined residence time. A person skilled in the art will further recognize that the aforementioned recognized factors may also be affected based on the specific aqueous solvent or solution being used, and also the specific alkali metal (including whether this is lithium or lithium carbonate) being used.

Fluid saturation may be determined by sampling the mixture over time and analyzing the lithium content. As the lithium content in the solution stops rising or plateaus, the solution may be in a saturated state. In a preferred embodiment, a saturated solution will have between 2,200 milligrams per liter and 2,500 milligrams per liter of lithium. Sampling and analysis of the mixture will be discussed further below.

In a preferred embodiment, where solid lithium particles are solid lithium carbonate particles with a grain size of less than 25 microns, and where the aqueous solvent is purified water, the predetermined residence time may be at least four hours. During the predetermined residence time, the mixture of solid lithium carbonate particles and the purified water may be continuously stirred.

At block 220, after the predetermined time has elapsed, a sample of the mixture of solid lithium and lithium solution (also referred to herein as a lithium mixture) may be extracted for analysis. The sample may have the solid lithium removed either through a filter that is similar to filter 128, or through similar means upon which the lithium solution is to be filtered through at block 225, the process of which will be further discussed below.

Once the sample of lithium solution has been filtered, it may be analyzed to determine the lithium content or its saturation level. Specifically, the lithium solution may be analyzed to determine if the lithium content is sufficient. The is depicted at block 223. In a preferred embodiment, the lithium content in a saturated lithium solution may be at least 2,200 mg/L. If the filtered sample of lithium solution does not meet the predetermined saturation level, the amount of residence time for additional dissolving and/or mixing of the solid lithium with the aqueous solution and/or solvent may be increased. This is depicted by returning to block 215, after which another sample may be extracted for analysis. In addition or in the alternative, the amount of solid lithium added to the aqueous solution or solvent in mixer 120 may also be further increased. A person skilled in the art will recognize that the predetermined saturation level may be different depending on the alkali metal introduced to the solution.

If at block 223, the sample of filtered lithium solution is analyzed, and it meets the predetermined saturation level, the mixture of lithium solution and residual solid lithium particles that have yet to be dissolved in mixer 120 may then be separated using filter 128, as is depicted at block 225. Once filtered, the saturated liquid lithium solution may have a lithium content within said saturated lithium solution that is similar to the sample that is tested at block 223. In a preferred embodiment, once filtered using filter 128, the saturated liquid lithium solution may have a lithium content in the saturated liquid lithium solution of at least 1,000 mg/L. In addition, in a preferred embodiment, the total residual suspended solid content of the saturated liquid lithium solution may be less than 1 mg/L. A person skilled in the art will recognize that the total residual suspended content may be altered depending on the application of the saturated liquid lithium solution. For example, in situations where the flow of the fire suppression medium may go through a nozzle, a lower total residual suspended solid content may be required to prevent blockages through the nozzle.

At block 230, the saturated liquid lithium solution is then collected to be provided to a range of fire suppression devices, which will be further discussed below.

Referring to FIG. 2B, an alternate method for producing the fire suppression medium for extinguishing lithium based fires and to prevent or stop runaway lithium oxidation reactions is provided. For convenience, like reference numerals are used in FIGS. 2A and 2B to depict like steps. Method 200A is similar in all material respects to method 200 except that there is an additional block 235.

Blocks 205, 210, 215, 220, 223, 225 and 230 are performed as described above in the context of method 200 shown in FIG. 2A. Block 235 may occur either concurrently, before or after block 230. In the current embodiment, as is depicted in FIG. 2A, block 235 occurs concurrently with block 230. At block 235, any leftover residual solid lithium carbonate may also be collected to be reused at block 210, where the leftover residual solid lithium carbonate may be re-introduced into the aqueous solvent or solution. A person skilled in the art will also recognize that in alternative embodiments, any leftover residual solid lithium that is collected, may also be used and/or treated for alternative purposes, such as raw material for the construction of batteries. A person skilled in the art will also recognize that in other embodiments where other alkali metals are used, that leftover residual alkali metals may also be collected for re-use.

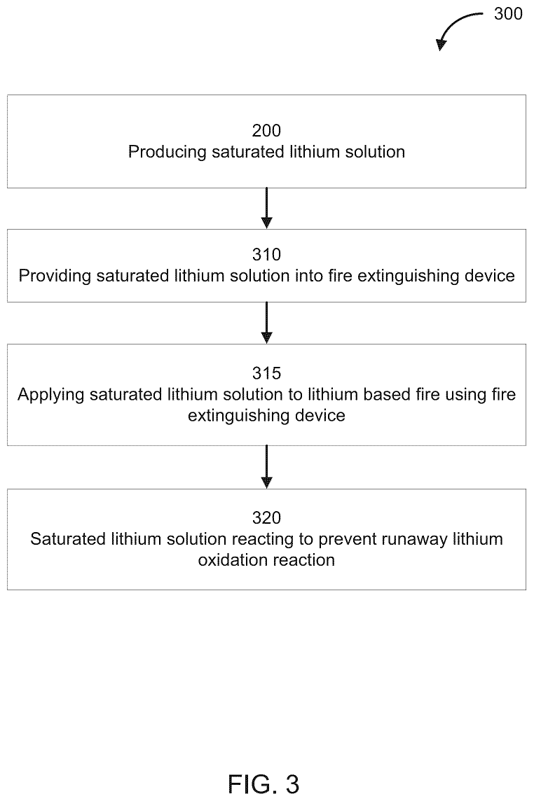

FIG. 3 depicts method 300 as an example method of using the fire suppression medium for extinguishing lithium based fires and to prevent or stop runaway lithium oxidation reactions. Block 200 represents the production of the saturated liquid lithium solution as is provided above as method 200.

Once the saturated liquid lithium solution is ready to be used, at block 310, the saturated liquid lithium solution may be included in fire suppression devices. An example of a fire suppression device that may use the saturated liquid lithium solution is a handheld fire extinguisher. The handheld fire extinguisher may be filled with the saturated liquid lithium solution under pressure along with other chemicals and/or components and the applied to lithium based fires, as can be seen at block 315.

More specifically, handheld fire extinguishers (also referred to herein as fire extinguishers) may be filled with a mixture of the saturated liquid lithium solution and either compressed air, or a mixture of gaseous carbon dioxide and liquid carbon dioxide. Specifically, class A fire extinguishers for putting out lithium based fires may be made by filling the class A fire extinguisher tank with the saturated liquid lithium solution and compressed air. Class B fire extinguishers for putting out lithium based fires may be made by filling the class B fire extinguisher tank with the saturated lithium solution and compressed gaseous carbon dioxide. Class C fire extinguishers for putting out lithium based fires may be made by filing the class C fire extinguisher tank with the saturated lithium solution, a layer of liquid carbon dioxide and a layer of compressed gaseous carbon dioxide.

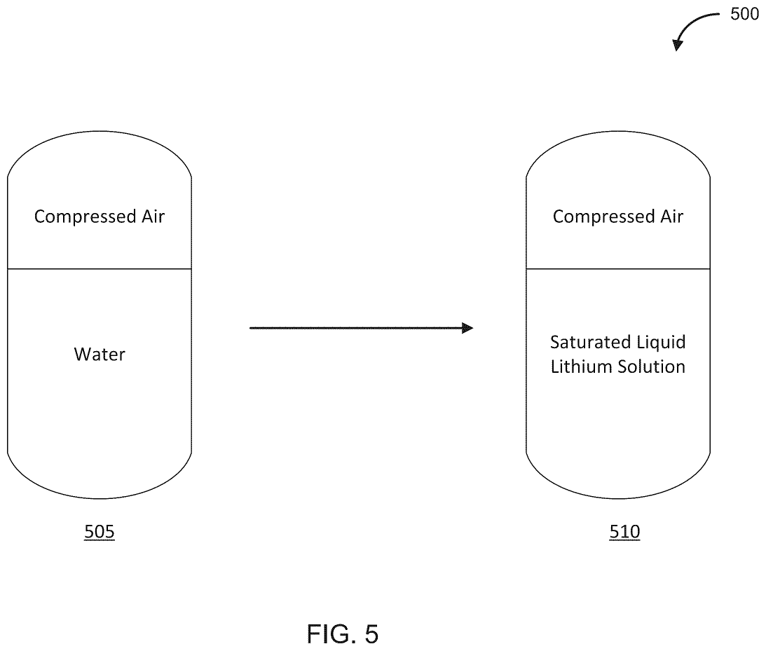

Existing fire extinguishers may also be modified to use the saturated liquid lithium solution. Referring to FIG. 5, an example modification 500 for a fire extinguisher is depicted, where the saturated liquid lithium solution is used as a class A suppression medium. Fire extinguisher 505 with a class A suppression medium (also referred to herein as a class A fire extinguisher) may include water and compressed air, where water mist and/or water spray is used to extinguish fires. Class A fire extinguishers are commercially available and known in the art, and as such, a person skilled in the art will recognize the compositions and functionality of class A fire extinguisher 505. Class A fire extinguisher 505 may be converted to a modified fire extinguisher 510 that uses a class A suppression medium including saturated liquid lithium solution and compressed air. More specifically, the class A fire extinguisher 505 may be converted to a modified class A fire extinguisher 510 by replacing the water in fire extinguisher 505 with saturated liquid lithium solution and then adding compressed air to allow of the spraying and dispersal of the saturated liquid lithium solution.

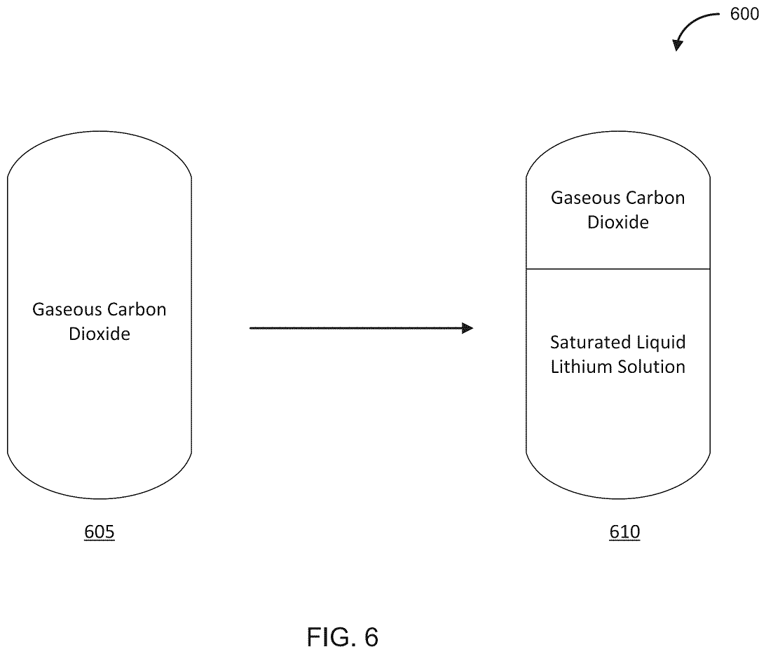

Referring to FIG. 6, an example modification 600 for a fire extinguisher is depicted. Fire extinguisher 605 with a class B suppression medium (also referred to herein as a class B fire extinguisher) may include gaseous carbon dioxide, where the carbon dioxide is sprayed onto the fire and suffocates the fire. Class B fire extinguishers are commercially available and known in the art, and as such, a person skilled in the art will recognize the compositions and functionality of class B fire extinguisher 605. Class B fire extinguisher 605 may be converted to a modified fire extinguisher 610 that uses a class B suppression medium including saturated liquid lithium solution and compressed gaseous carbon dioxide. More specifically, the class B fire extinguisher 605 may be converted to a modified class B fire extinguisher 610 by replacing a portion of the gaseous carbon dioxide with the saturated liquid lithium solution. The remaining compressed gaseous carbon dioxide in modified class B fire extinguisher 610 allows for the spraying and dispersal of the saturated liquid lithium solution.

Other fire suppression mediums for different classes of fires may also be available. For example, a class C suppression medium may include a pressurized saturated liquid lithium solution, liquid carbon dioxide and compressed gaseous carbon dioxide. The liquid carbon dioxide and compressed gaseous carbon dioxide provides a longer lasting pressure supply when spraying and dispersing the saturated liquid lithium solution.

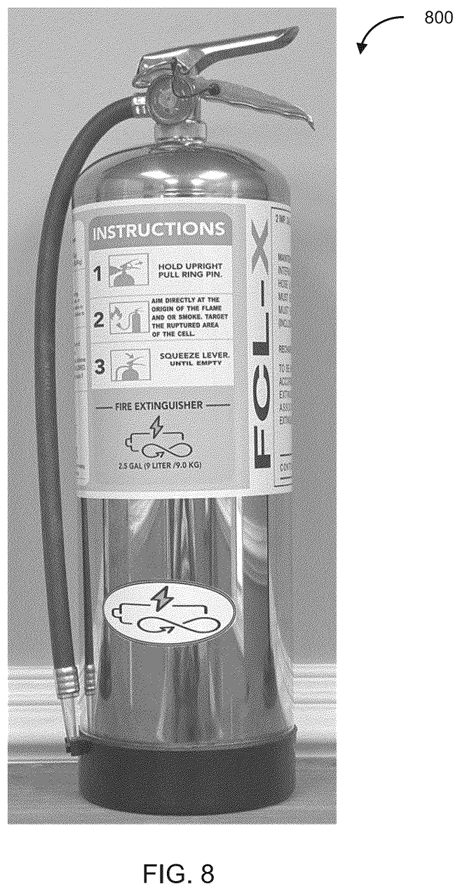

Referring to FIG. 8, an example portable fire extinguisher product 800 is depicted. In the current embodiment, the contents of portable fire extinguisher product 800 have been filled with saturated liquid lithium solution and compressed air, as is previously described in modified class A fire extinguisher 510. Furthermore, in a preferred embodiment, portable fire extinguisher product 800 has a volume of approximately 2.5 gallons or 9 liters of saturated liquid lithium solution. However, a person skilled in the art will recognize that a portable fire extinguisher 800 may be of any volume.

In other embodiments, saturated liquid lithium solution may be used as an additive to fire hoses. For example, a saturated liquid lithium solution may be injected into a water flow in a fire hose to further coat lithium based fires.

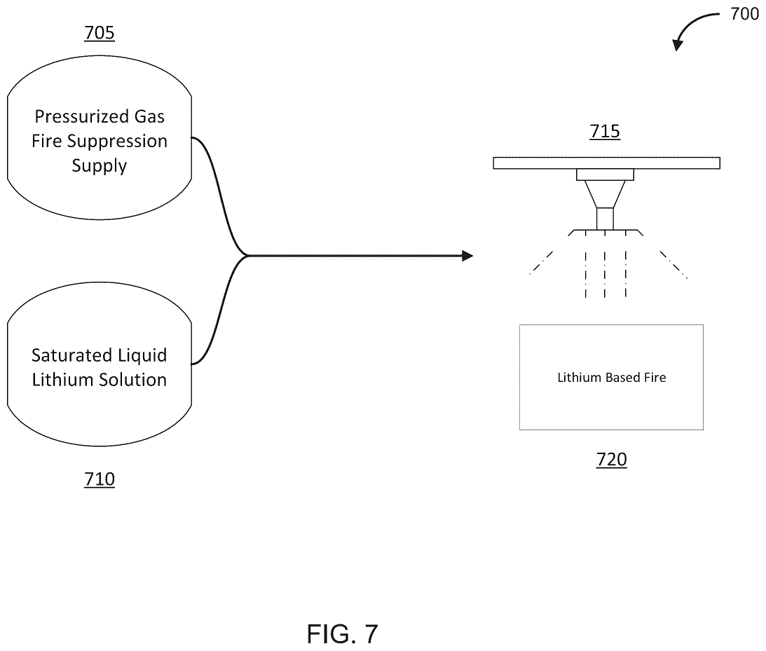

In yet another alternative embodiment, saturated liquid lithium solution may be used as part of a pressurized gas fire suppression system, such as a sprinkler system, or other known systems that may be integrated into buildings. Referring to FIG. 7, a pressurized gas fire suppression system 700 that uses the saturated lithium solution as part of the fire suppression medium is shown. Storage tank 705 includes a pressurized gas fire suppression supply. Examples of a pressurized gas fire suppression supply include air pressurized, nitrogen pressurized, argon pressurized, and carbon dioxide pressurized supplies. Storage tank 710 includes the saturated liquid lithium solution. Both the pressurized gas fire suppression supply and the saturated liquid lithium solution may be mixed and then fed through sprinkler 715 when activated or when there is a lithium fire based fire detected. In the current embodiment, sprinkler 715 may be installed above a large storage of LIBs, however, it will occur to a person skilled in the art that sprinkler 715 may be installed in any location where there is the potential for a lithium based fire. In yet another embodiment (not shown), valves may be installed between storage tank 710 and sprinkler 715, allowing for the control of the amount of saturated lithium based solution to be provided as part of the fire suppression medium through sprinkler 715. A controller (not shown) may be provided to either control the amount of saturated lithium based solution, or if it is known that the fire is not lithium based, to shut off the valve and prevent the saturated liquid lithium solution from being included as part of the fire suppression medium. A person skilled in the art will recognize the variations and arrangements for including and controlling the saturated liquid lithium solution in the pressurized gas fire suppression system. A person skilled in the art will also recognize different embodiments to those depicted in FIGS. 5 to 7, and also other fire suppression systems, where a saturated alkali metal based solution may be used as the fire suppression medium.

In yet another alternative embodiment, saturated liquid lithium solution may be used as part of engineered fire suppression systems. A person skilled in the art will recognize that engineered fire suppression systems are fire suppression systems designed for facilities, warehouses and buildings and may include a variety of components, including detectors, alarms, sprinkler systems and suppression against. Other uses for engineered fire suppression systems includes, but is not limited to, manufacturing plants, power generation facilities, data centres, large marine and land vehicle applications, industrial paint lines, dip tanks and electrical switch rooms. Engineered fire suppression systems may also be used in facilities where hazardous materials are stored. In the current embodiment, engineered fire suppression systems may include the saturated lithium solution as a suppression agent, where the engineered fire suppression system may be installed in environments where LIBs are present.

Portable fire extinguishers 510, 610 and 800 may be refilled with saturated liquid lithium solution upon depletion of the fire suppressant from the fire extinguishers 510, 610 and 800. Alternatively, the saturated liquid lithium solution in portable fire extinguishers 510 610 and 800 may need to be replaced at regular intervals to adhere to fire codes or regulations. Similarly, the input storage or tank for saturated liquid lithium solution of pressured fire suppression systems 700 and other engineered fire suppression systems may also need to be refilled after depletion or be replaced at regular intervals. Refills of the saturated liquid lithium solution may be provided in various wholesale or bulk containers, including, but not limited to, a pail, a drum, or a tote. A user may use the wholesale or bulk containers to refill portable fire extinguishers 510, 610 and 800, or pressured fire suppression system 700 or engineered fire suppression systems. A person skilled in the art will recognize that refills are not limited to wholesale or bulk containers, but may be provided in vessels of any volume or size. Refills may also be provided via other means, such as via a pump and hose from a truck.

Alternatively, saturated liquid lithium solutions may be pre-emptively provided in combination with lithium based apparatuses or lithium fire residue that have a potential to catch on fire. For example, LIBs that may be in EVs have a risk of igniting during collisions or impacts. The saturated liquid lithium solution may be placed in a package, where upon the application of extreme heat from a potential battery fire or other trigger, the saturated liquid lithium solution may be released into the surrounding area of the LIB, potentially extinguishing the LIB fire. In another embodiment, the package of saturated liquid lithium solution may be heat triggered to release the saturated liquid lithium solution. Once the lithium based fire has been suppressed, the LIB continues to be surrounded by the saturated liquid lithium solution, preventing it from igniting again, and rendering the LIB safe.

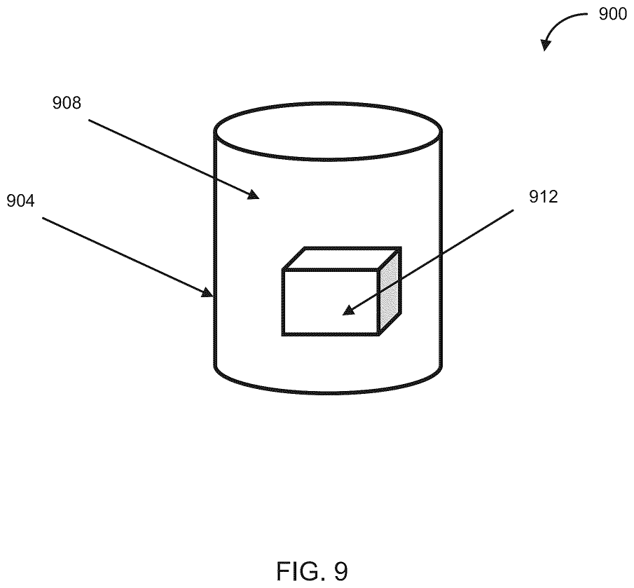

Referring to FIG. 9, a preferred embodiment of a transportation vessel 900 (also referred to as bulk transportation container 900) is depicted for the safe transportation of lithium fire residue to another location, such as to a site for final disposition. Transportation vessel 900 includes drum 904 and saturated liquid lithium solution 908, where the lithium fire residue 912 is immersed or submerged in saturated liquid lithium solution 908. Specifically, transportation vessel 900 includes drum 904 which contains lithium fire residue 912 and a sufficient volume of saturated liquid lithium solution 908 to prevent further reaction. More specifically, by immersing or submerging the lithium fire residue 912 in saturated liquid lithium solution 908, the lithium fire residue 912 will be prevented from re-igniting. In using transportation vessel 900, the lithium fire residue 912 may be placed within a pre-filled drum 904 of saturated liquid lithium solution 908, or alternatively, lithium fire residue 912 may be placed within drum 904 first, and then drum 904 may be filled with saturated liquid lithium solution 908.

Drum 904 contains or acts as a containment for saturated liquid lithium solution 908 and lithium fire residue 912, allowing it to be easily transported. Drum 904 may be of any size, however, in a preferred embodiment, drum 904 is a U.S. Department of Transportation rated steel transport drum of either five (5) gallons or fifty-five (55) gallons. Furthermore, drum 904 may be of any material that does not react to lithium or saturated liquid lithium solution 912. A person skilled in the art will recognize the different configurations and materials of drum 904.

Lithium fire residue 912 is the remnants of any lithium based fire that may contain lithium and hence may re-ignite. Examples of lithium fire residue 912 include, but is not limited to, the leftover material from a LIB after it has gone through a lithium based fire, or a damaged LIB. However, a person skilled in the art will recognize that transportation vessel 900 is not limited to the transportation of lithium fire residue 912, but may be used for the transportation of material containing lithium that may be damaged or suspected of being damaged, and may have a risk of igniting or catching fire. For example, a damaged LIB or suspected to be damaged LIB after a collision may be transported in transportation vessel 900 to prevent the potential of ignition and fire. A person skilled in the art will recognize that transportation vessel 900 may be used to transport any material or apparatuses that have lithium that have a risk of igniting.

Once the saturated liquid lithium solution is applied to a lithium based fire, the saturated liquid lithium solution (e.g. lithium carbonate solution) may stop or diminish any further reaction of the lithium present in the fire, preventing any future lithium oxidation reactions. Specifically, the lithium carbonate solution interferes and slows the rate of the oxidation reaction, reducing the rate of heat buildup and gas release, and hence reducing the risk of a runaway reaction. Since the oxidation of elemental lithium is autocatalytic, the rate of reaction of elemental lithium to form lithium ions depends on the pH and is faster at a higher pH. The reaction itself produces alkalinity, which increase the pH, and as such, once the reaction starts, the reaction rate may increase over time until all the lithium present has reacted. Using the saturated liquid lithium solution (or in other embodiments, a saturated alkali metal solution, or more preferably a saturated liquid lithium carbonate solution) interferes with the autocatalytic reaction and in so doing provides a useful impediment to rapid lithium oxidation.

When applying the saturated liquid lithium solution to the lithium based fire, the saturated lithium solution coats the surface of the components on fire, such as the surface of LIBs where lithium oxidation may be taking place. Due the to nature of the surface coating property, small volumes of saturated liquid lithium solution may be used to extinguish lithium based fires. Furthermore, smaller volumes of saturated liquid lithium solution may be used in comparison to other known prior art suppression mediums for extinguishing lithium based fires of similar sizes, surface area and intensity. For example, the volume of water used as an suppression medium for lithium based fires is commensurate with the energy it takes to vaporize water to steam, which acts to cool the fire. Furthermore, it is estimated that the volume of water required to extinguish a lithium based fire of any size may be approximately ten times in volume in comparison to the volume of saturated liquid lithium solution that may be used.

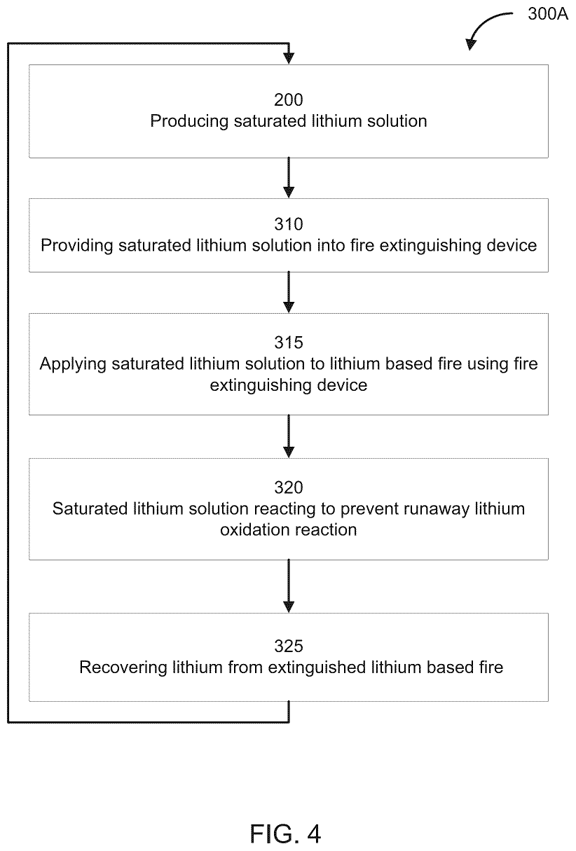

FIG. 4 depicts method 300A, an alternate embodiment of method 300 of using the fire suppression medium for extinguishing lithium based fires and to prevent runaway lithium oxidation reactions. Method 300A has similar steps to method 300, and blocks 200, 310 to 320 follow the same process.

Block 325 depicts recovering lithium from the extinguished lithium based fire that is covered with the saturated liquid lithium solution. Using a lithium solution does not add any chemical constituents, and as such, lithium may be extracted to be re-used and/or processed for other means, such as purified lithium products. Alternatively, as can be seen in method 300A, the extracted lithium may be processed into solid lithium salts to be re-used in block 200/method 200 to produce additional liquid saturated lithium carbonate solution. More specifically, the extracted lithium may be returned to solid lithium storage 112 to be re-processed into the saturated lithium solution. By processing the used saturated liquid lithium solution, there is minimal waste generation, and reduces the need for special disposal of any contaminated fluids.

Fire suppression mediums may also be required for LIBs with permeable graphite anodes, or with other materials that may be cheaper or better performing, such as graphite-silicon composites or similar materials. Where alternate embodiments of liquid saturated lithium solutions may be more effective as fire suppression mediums for LIBs with other materials, system 100 may further include additional storage (not shown) to introduce additional components to mixer 120 for the creation of said alternate embodiment of liquid saturated lithium solution. For example, an additional storage (not shown) of a surface reactive hydrophilic material may be added to system 100 and introduced to mixer 120, where the surface reactive hydrophilic material may encourage coating of a LIBs that may undergo fires or exothermic reactions. A person skilled in the art will recognize the different components or surfactants that may be added to the creation of liquid saturated lithium solutions, and the different arrangements for introducing said different components or surfactants in system 100.

In a preferred embodiment, a saturated lithium solution is created by adding solid lithium (preferably, lithium carbonate but other alkali salts may be used) to an aqueous solvent or solution. The lithium salt partially dissolves and saturates the solution. The solution is then decanted from the solids. The decanted (solid-free) solution is the solution used in the tests (“lithium solution”).

In a preferred embodiment, approximately 15 gallons of the lithium solution of the present invention may be used to extract lithium from a single LIB or lithium ion battery derived materials (e.g. during recycling). Several tests were carried out in sequence using the same lithium solution for each test (the lithium solution was recycled test to test). Tests were carried out in parallel in which pure aqueous solvent (e.g. water) was used to extract the lithium instead of lithium solution. Using pure water showed noticeable heating and gas evolution immediately in the first test. The extraction was performed in a carefully controlled way in order to not get localized heating and gas release.

In contrast, using the lithium solution of the present invention for the extractant did not show evidence of localized heating or gas release. Only after multiple tests (6 or more) did the heating and gas release become a problem, presumably because the lithium solution had lost its ability to slow the reaction due to lithium or alkali metal depletion.

It is the view that the use of the lithium solution of the present invention interferes with and lowers the rate of the oxidation reaction. This therefore may reduce the rate of heat buildup and gas release and may allow these factors to be controlled more easily and reducing the danger of a runaway reaction.

It is also of the view that the oxidation of elemental lithium is itself autocatalytic. The rate of reaction of elemental lithium to form lithium ions depends on pH, and is faster at higher pH. The reaction itself produces alkalinity (increases the pH), so once started, the reaction rate will increase over time until all lithium has reacted. This behavior may be common to chemical reactions used for explosives. The lithium solution of the present invention interferes with the autocatalytic reaction and in so doing provides a useful impediment to rapid lithium oxidation.

Using a lithium solution of the present invention in the processes described here, does not add any new chemical constituents to the extracted lithium stream that would later have to be removed to make purified lithium products. Since lithium carbonate may be used to create further products, or even saturated liquid lithium solution, it may simplify our supply chain. The overall process is both sustainable and has a very small carbon footprint compared to competing recycling processes.

In a preferred embodiment, the saturated lithium solution used in the abovementioned vessels, including but not limited to, portable fire extinguishers 510, 610 and 800, pressurized gas fire suppression system 700, other engineered fire suppression systems, additives to fire hoses, pails, drums, totes and other wholesale or bulk containers has the product name FCL-X™. This is also depicted in FIG. 8 on portable fire extinguisher 800.

Although the foregoing description and accompanying drawings to specific preferred embodiments of the present invention as presently contemplated by the inventor, it will be understood that various changes, modifications and adaptations, may be made without departing from the spirit of the invention.

The invention claimed is:

1. A method of producing a fire suppression medium comprising:
introducing a solvent into a mixer;
introducing an alkali metal or a salt of the alkali metal into the mixer;
dissolving the alkali metal or the salt of the alkali metal in the solvent to create an alkali metal solution;
filtering a sample of the alkali metal solution;
analyzing the sample of the filtered alkali metal solution;
if the filtered alkali metal solution does not have a sufficient alkali metal content:
introducing an additional solid alkali metal or the salt of the alkali metal into the mixer;
dissolving the additional solid alkali metal or salt of the alkali metal into the alkali metal solution; and
further analyzing a second sample of the alkali metal solution for sufficient alkali metal content;
if the filtered alkali metal solution has the sufficient alkali metal content:
filtering the alkali metal solution to remove residual alkali metal or residual salt of the alkali metal to create a saturated alkali metal solution; and
collecting the saturated alkali metal solution.

2. The method of claim 1 further comprising collecting the residual alkali metal or salt of the alkali metal and re-introducing the residual alkali metal or the sale of the alkali metal into the mixer.

3. The method of claim 1, wherein dissolving the alkali metal or the salt of the alkali metal in the solvent includes stirring the alkali metal solution with a stirrer in the mixer.

4. The method of claim 1, wherein the solvent is water.

5. The method of claim 1, wherein the alkali metal is the salt of the alkali metal.

6. The method of claim 1, wherein the salt of the alkali metal is selected from the group consisting of lithium carbonate, lithium bicarbonate and lithium chloride.

7. The method of claim 1, wherein the sufficient alkali metal content is at least 2,200 mg/L.

8. A system for producing a fire suppression medium comprising:
a mixer, the mixer configured to receive a solvent and an alkali metal or a salt of the alkali metal to dissolve the alkali metal or the salt of the alkali metal into the solvent to create an alkali metal solution; and
a filter fluidly connected to the mixer, the filter configured to separate a residual alkali metal or a residual salt of the alkali metal from the alkali metal solution leaving a saturated alkali metal solution.

9. The system of claim 8, wherein the mixer includes a stirrer.

10. The system of claim 8, wherein the solvent is water.

11. The system of claim 8, wherein the alkali metal is the salt of the alkali metal.

12. The system of claim 8, wherein the salt of the alkali metal is selected from the group consisting of lithium carbonate, lithium bicarbonate and lithium chloride.

13. The system of claim 8, wherein the saturated alkali metal solution has an alkali metal content of at least 2,200 mg/L.

14. A fire suppression medium comprising:
a saturated alkali metal solution, the saturated alkali metal solution comprising:
a solvent; and
an alkali metal or a salt of the alkali metal dissolved in the solvent;
wherein the saturated alkali metal solution has an alkali metal content of at least 2,200 mg/L.

15. The fire suppression medium of claim 14, wherein the solvent is water.

16. The fire suppression medium of claim 14, wherein the salt of the alkali metal is selected from the group consisting of lithium carbonate, lithium bicarbonate and lithium chloride.

17. A fire extinguisher comprising the fire suppression medium of claim 14.

18. An engineered fire suppression system comprising a suppression agent, wherein the suppression agent includes the fire suppression medium of claim 14.

19. A bulk container comprising the fire suppression medium of claim 14, the bulk container configured to refill a fire extinguisher, a pressurized gas fire suppression system or an engineered fire suppression system.

20. A bulk transportation container comprising the fire suppression medium of claim 14, the bulk transportation container being configured to transport at least one of a lithium fire residue, a damaged lithium ion battery and a suspected to be damaged lithium ion battery.
